(19) United States
(12) Patent Application Publication
(10) Pub. No.: US 2003/0084290 A1
(43) Pub. Date: May 1, 2003

(54) Distributed security architecture for storage area networks

(76) Inventors: Kumar Murty, Toronto (CA); Vladimir Kolesnikov, Toronto (CA); Daniel Thanos, Ontario (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/269,934

(22) Filed: Oct. 11, 2002

(30) Foreign Application Priority Data
Oct. 12, 2001 (CA) 2,358,980

(51) Int. Cl. H04L 9/00

(52) U.S. Cl. 713/168; 380/277

(57) ABSTRACT

The invention relates to a method of transferring data between a host computer server and a secure network storage system via a data transfer architecture. The secure network storage system has a plurality of storage devices for storage of the data. The method comprises (a) authenticating the host computer server with a security system associated with the secure network storage system; (b) obtaining a storage key from the security system after authentication; and (c) performing an encryption/decryption operation comprising at least one of (i) encrypting and storing data on the secure network storage system, and (ii) retrieving and decrypting data stored on the secure network storage system.

### FIELD OF THE INVENTION

The invention relates generally to secure transmission and storage of data in computer systems, and more specifically relates to a distributed security architecture for storage area networks.

### BACKGROUND OF THE INVENTION

With the proliferation of computing devices and users, the individual size and number of files are growing exponentially. Concurrently, the demand by users for immediate and constant access to these files is also growing. Storage networks are used to satisfy these demands.

Storage networks have evolved significantly over the last few years to meet the growing demands for enterprise-wide data access, high performance and to prevent bottlenecks. These storage networks also give organizations the ability to perform offline backups and centralized management. They also improve resource sharing, systems scaling and performance of the entire system.

As they recognize the importance of storage networks and begin to implement larger storage area networks, organizations will face new challenges. Storage networks are now being interconnected over longer distances and within increasingly complex varieties of storage devices. While these networks are highly convenient and productive for the organization, the same features that provide these benefits also give rise to underlying weaknesses within the storage network model—specifically, exposure to unexpected security breaches and attacks.

Accordingly, there is a growing need for security and authentication across storage area networks. As they provide access to more users, maintaining and enforcing corporate security policies and providing authentication becomes critically important. Information needs to be protected from unauthorized and malicious attacks.

As described above, storage networks were designed to provide data storage and constant access. Storage networks were not designed with strong, comprehensive security management in mind. As a result, data is often far too readily available and open to corruption and outright theft. In addition, the security mechanisms used in traditional corporate networks are simply not scaleable or comprehensive enough to be adapted for storage networks. While traditional networks provide local protection of data during transmission and user access control, they do not provide the robust encryption of data required for data storage.

A storage network is vulnerable at each junction across the fabric (at hosts, at switches, at devices and whilst data is in movement.) Whether a hacker enters the storage network at a web server, or a malicious employee breaks into the data center, the storage system can be compromised. In such cases, the entire storage network can be brought down and valuable information stolen or corrupted. Security tools have been devised to provide access control. Examples of such security tools are switch zoning and logical unit number masking. A number of problems may arise with the use of these security tools. Specifically, these security tools do not protect the communication of information into the storage network, or, sometimes, the communication of the information with the storage network. Further, implementing security capabilities in the wrong components of the storage network, or in the wrong place will put a burden on the switching and processing capabilities of the secure network storage system, potentially slowing down user access to the storage area network and thereby compromising its function.

Accordingly, a security system for storage area networks that provides certificate-based authentication, persistent encryption of data (during movement and storage) and transparent operation (across all hardware and software components found on the storage area network) is desirable.

### SUMMARY OF THE INVENTION

An object of an aspect of the present invention is to provide an improved post-side encryption module for encrypting data for storage on a storage area network, and for decrypting encrypted data received from the storage area network.

In accordance with this aspect of the invention there is provided a host-side encryption module for installation on a host computer server connected to a secure network storage system by a data transfer architecture for transfer of data therebetween. The secure network storage system has a plurality of storage devices for storage of the data. The host-side encryption module comprises: (a) an encryption/decryption means for encrypting data to be stored on the secure network storage system and for decrypting data received from the secure network storage system; (b) an authentication means for authenticating the host computer server with a security system associated with the secure network storage system; and (c) a key management means for (i) obtaining a key and associated storage identity information from the security system after authentication, wherein the associated storage identity information designates an associated storage means for storing information encrypted using the storage key, and the associated storage means is in the plurality of storage means, and (ii) providing the key to the encryption engine for encryption and decryption of data.

An object of a second aspect of the present invention is to provide an improved computer system for providing restricted access to a storage area network.

In accordance with a second aspect of the invention there is provided a security system for providing restricted access to data stored on a secure network storage system having a plurality of storage means. The security system comprises (a) data transfer means for communication with a host server computer and the secure network storage system; (b) a host computer authentication means for authenticating a host computer; (c) a key management means for issuing a storage key and associated storage identity information to the host computer following authentication, wherein the associated storage identity information designates an associated storage means for storing information encrypted using the storage key, and the associated storage means is in the plurality of storage means; (d) a key storage means for securely storing the storage key and the associated storage identity information.

An object of a third aspect of the present invention is to provide an improved computer program product for use on a host computer server.

In accordance with the third aspect of the invention there is provided a computer program product for use on a host computer server. The computer program product comprises: a recording medium and means recorded on the medium for configuring the host computer server to provide (a) an encryption/decryption means for encrypting data to be stored on the secure network storage system and for decrypting data received from the secure network storage system; (b) an authentication module for authenticating the host computer server with a secure source associated with the secure network storage system; and (c) a key management means for (i) obtaining a key from the secure source after authentication, and (ii) providing the key to the encryption engine for encryption and decryption of data.

An object of a fourth aspect of the present invention is to provide an improved secure storage network system.

In accordance with the fourth aspect of the invention there is provided a secure storage network storage system comprising (a) a host computer server; (b) a storage system connected to the host computer server by a data transfer architecture for transfer of data therebetween, the storage system having a plurality of storage devices for storage of the data; (c) a host-side encryption module installed on the host computer, and (d) a security system for providing restricted access to data stored on the storage system. The host-side encryption module has i) an encryption/decryption means for encrypting data to be stored on the secure network storage system and for decrypting data received from the secure network storage system; (ii) an authentication means for authenticating the host computer server with a security system associated with the secure network storage system; and (iii) a key management means for obtaining a key from the security system after authentication, and providing the key to the encryption engine for encryption and decryption of data. The security system includes (i) data transfer means for communication with the host server computer and the secure network storage system; (ii) a host computer authentication means for authenticating the host server computer; (iii) a key management means for issuing a storage key to the host computer following authentication; and (iv) a key storage means for securely storing the storage key.

An object of a fifth aspect of the present invention is to provide a host-side encryption module for installation on a host computer.

In accordance with the fifth aspect of the invention there is provided a host-side encryption module for installation on a host computer server connected to a secure network storage system by a data transfer architecture for transfer of data therebetween. The secure network storage system has a plurality of storage devices for storage of the data. The host-side encryption module includes (a) an encryption/decryption means for encrypting data to be stored on the secure network storage system and for decrypting data received from the secure network storage system; (b) an authentication means for authenticating the host computer server with a security system associated with the secure network storage system; and (c) a key management means for (i) obtaining a key from the security system after authentication, and (ii) providing the key to the encryption engine for encryption and decryption of data.

An object of a sixth aspect of the present invention is to provide an improved computer system for providing restricted access to a storage area network.

In accordance with the sixth aspect of the invention there is provided a method of transferring data between a host computer server and a secure network storage system via a data transfer architecture. The secure network storage system has a plurality of storage devices for storage of the data. The method comprises (a) authenticating the host computer server with a security system associated with the secure network storage system; (b) obtaining a storage key from the security system after authentication; and (c) performing an encryption/decryption operation comprising at least one of (i) encrypting and storing data on the secure network storage system, and (ii) retrieving and decrypting data stored on the secure network storage system.

### BRIEF DESCRIPTION OF THE DRAWINGS

FIG. 1, in a schematic view illustrates a secure network storage system in accordance with an aspect of the present invention;

FIG. 2, in a schematic view, illustrates a simplified version of the secure network storage system of FIG. 1;

FIG. 3, in a block diagram, illustrates a host-side encryption driver in accordance with a preferred aspect of the present invention;

FIG. 4, in a block diagram, illustrates the host side encryption driver of FIG. 3 and its functional relationship with the host computer and the storage area network; and,

FIG. 5 in a block diagram, illustrates a storage area network security appliance in accordance with a further preferred embodiment of the present invention.

### DETAILED DESCRIPTION OF PREFERRED EMBODIMENTS

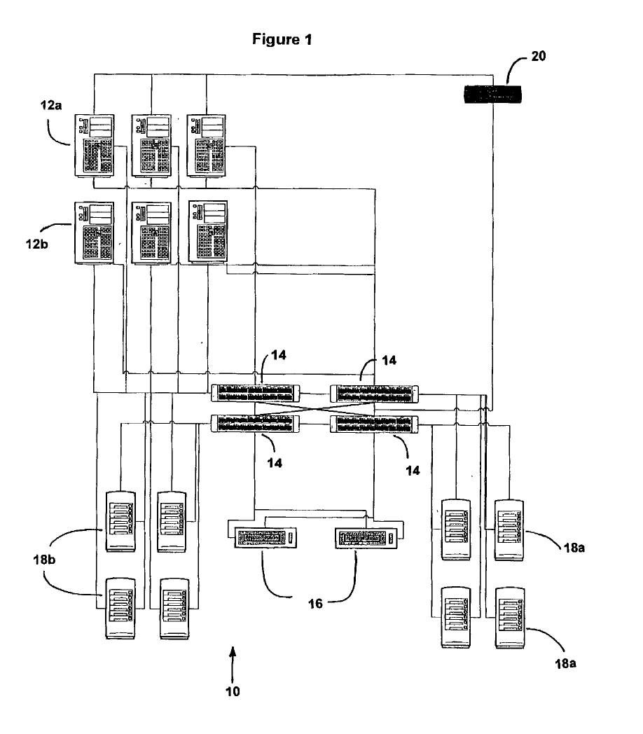

Referring to FIG. 1, there is illustrated in a schematic view, a secure network storage system 10 in accordance with a preferred embodiment of the present invention. As with known network storage systems, the secure network storage system 10 of the present invention includes host servers 12, storage network switches 14, tape arrays 16 and RAID arrays (storage devices) 18. RAID arrays 18 are redundant arrays of independent discs (or inexpensive discs) by which the same data can be saved in many different places using multiple hard discs. Tape arrays are more commonly used for archiving and back up. Users can access these storage devices to store or retrieve data through the host servers. The storage network switches 14 switches route messages to and from the host servers. Unlike prior storage network, however, the secure network storage system 10 of the present invention also includes a security appliance 20.

Among the host servers 12 are regular host servers 12b and secure host servers 12a. Host symmetric encryption drivers are installed on the secure host servers 12a. The RAID arrays 18 are also divided into two groups: regular RAID arrays 18b and secure RAID arrays 18a. In operation, secure host servers 12a can optionally store data on secure RAID arrays 18a by obtaining a storage key corresponding to the particular RAID array 18a and encrypting at the secure host server 12a before transmitting the encrypted data to the RAID array 18a. The regular host servers, on which host storage encryption drivers have not been installed, cannot obtain a key from the security appliance 18. These regular hosts 12b cannot, therefore, write data to the secure RAID arrays 18a, but only to the regular RAID arrays 18b. Other than the fact that the data from the secure host servers 12a is encrypted, the data from the secure host servers 12a is transmitted to the RAID arrays 18 in exactly the same way as the data from the regular host servers 12b.

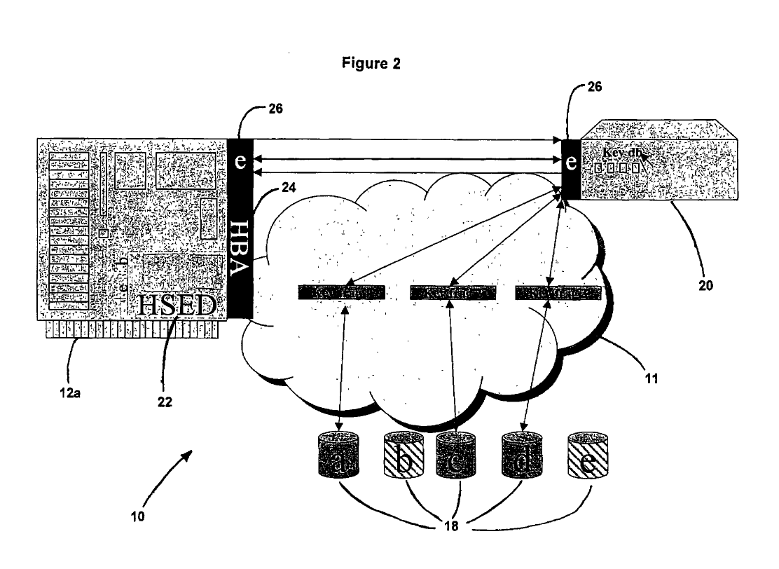

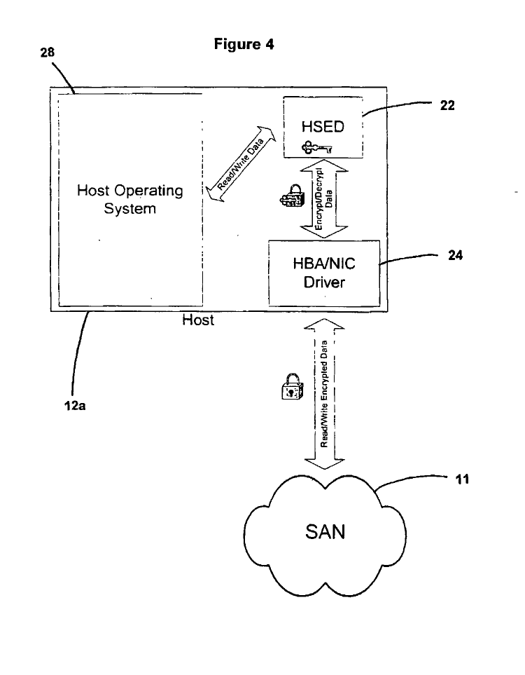

Referring to FIG. 2, a simplified version of the secure network storage system 10 is illustrated in a schematic view. The secure network storage system 10 includes a storage area network 11, the security appliance 20 and a secure host server 12a. As shown in FIG. 2, the host server 12 includes a host storage encryption driver (HSED) 22. This host storage encryption driver 22 may be either a software module on the host server 12a or preferably, may be a hardware card or blade that is incorporated into the host server 12a. The host storage encryption driver 22 is located between the operating system 28 (FIG. 4) on the host server 12a and the storage area network attached driver 24 (the host bus adapter (HBA) or network interface controller (NIC)). According to a preferred embodiment of the invention, the HBA/NIC driver 24 and the HSED are amalgamated into one module. When the host server 12a attempts to write data on the storage area network through the driver 24, the HSED intercepts and encrypts this data using a symmetric storage key 26 before the data is forwarded to the storage area network (SAN) attached drive. When the host server 12 requests data from the SAN drive 24, the HSED 22 intercepts the incoming data and decrypts (using the symmetric storage key 26) what is read from the drive before delivering this information to the host server 12a. Thus, the encryption and decryption are transparent or are not perceived by the host server 12 itself. A block diagram illustrating these operations is shown in FIG. 4.

To obtain the symmetric storage key, the HSED 22 must authenticate itself with the security appliance 20. This authentication may be achieved in any one of a number of different ways, but preferably involves the HSED 22 sending a certificate signing request to the security appliance 20, which certificate signing request contains: a shared secret known only to the security appliance 20 and the HSED 22, a HSED 22 public key to be turned into a certificate, an HSED 22 randomly generated session key. The certificate signing request is then encrypted using the session key, and the session key is encrypted using the security appliance 20 public key which has been pre-distributed to the HSED 22. The security appliance 20 can then decrypt this request using its private key to decrypt the session key and the session key to decrypt and verify the shared secret in the certificate signing request, thereby authenticating the HSED 22 certificate signing request. On this authentication, the security appliance 20 issues a certificate signed using the private key of the security appliance 20. The HSED 22 need only obtain the certificate once from the security appliance 20. Once it has the certificate, regardless of whether it is writing data to the secure RAID arrays 18a or retrieving data from the secure RAID arrays 18a, it starts with the following steps. The HSED 22 sends a request to the security appliance 20 for access to a secure storage device 18a. This request is encrypted using the a randomly generated session key (which is encrypted using the appliance public key) and signed using the HSED 22 private key and includes the access request, the HSED certificate previously issued by the security appliance 20, as well as the randomly generated session key for encrypting subsequent communications regarding this particular transaction between the HSED 22 and the security appliance 20. The security appliance 20 on receiving this request first authenticates the HSED 22 by verifying the request signature. Then, the security appliance 20 retrieves a list of storage key packages that this particular HSED 22 is allowed to access, as well as the storage device associations for these storage key packages. To elaborate, each of the secure storage devices 18a has an associated storage key that is used to encrypt data stored on that particular secure storage device 18a. Different secure storage devices 18a will have different storage keys and will be accessible by different secure host servers 12a. Thus, the security appliance 20 has to check for each secure host server 12a, which secure storage devices 18a it has access to. Once this information has been determined, the security appliance 20 prepares a response to the request from the HSED 22. This response is encrypted using the random session key and signed using the security appliance 20 private key (also identified as the security appliance root key component 57) and is sent to the security appliance 20 by the HSED 22 and includes the storage key package, storage device associations and the security appliance 20 certificate.

When this response is received by the HSED 22, it first authenticates the security appliance 20 by verifying the signature of the response and then decrypts the response using the random session key. In the case of encryption of data, it uses the storage key thus obtained to encrypt data before writing the data to a secure storage device 18a identified in the response by the storage device associations. In the case of decryption of data, the HSED 22 will retrieve the encrypted data from the secure storage devices 18a identified by the storage device associations, and then decrypt this data using the storage key. In either case, after a period of time has elapsed from the response being sent, the security appliance 20 may optionally send a request to the HSED 22 to zeroize/erase the storage key. The HSED 22 will zeroize/erase the storage key. On detection of tampering or improper access the HSED 22 will zeroize/erase the storage key using the key management sub module 35. Similarly if the security appliance 20 will on detection of tampering or improper access will zeroize/erase the storage key using the key erasing module 54

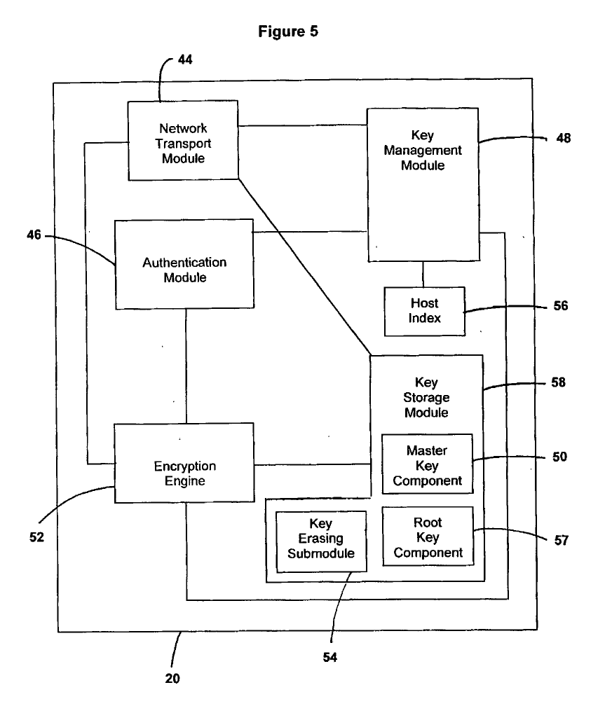

Preferably, before being stored on the secure storage devices 18a, the storage key is encrypted using a master key stored on a master key hardware component 50 (FIG. 5) in the security appliance 20. According to one embodiment, the security appliance 20 encrypts the storage key using the master key before writing the storage key to one of the secure storage devices 18a. However, according to the preferred embodiment illustrated in FIG. 2, the storage key is stored according to a secret sharing scheme such as that described by A. Shamir (“How to Share a Secret”, Communications of the ACM, Vol. 22, 1979, pp. 612-613) and G. R. Blakley (“Safeguarding Cryptographic Keys”, AFIPS Conference Proceedings, Vol. 48, 1979, pp. 313-317). Shamir describes an easy and efficient (t, n) secret sharing scheme. According to this scheme, the secret s is distributed among n participants, such that any t shares of the total n gives no information about the secret, but any t+1 shares allow for complete reconstruction of the secret. The holder of the secret constructs a monic polynomial of degree t+1 where each coefficient, except the constant term (and, of course, the highest degree term) is uniformly random. The constant term of the polynomial is set equal to the secret. The polynomial is then evaluated at n different non-zero points. Each of the n participants is sent exactly one of the n values, so that all of the values are distributed between the participants. Now, any number of polynomial evaluations up to and including t points is insufficient to gain any information about the constant term of the polynomial, while t+1 points allows unique determination of the polynomial by -solving a system of t+1 linear equations, thereby enabling determination of the constant term, which is the secret.

According to an aspect of the present invention, this secret sharing scheme is adapted for use in a storage area network 11. The secret s is a symmetric storage key 26. The participants could be switches, storage devices or any other devices that can store key fragments (and shares) on the storage area network 24. In FIG. 2, the participants are particular storage devices 18 designated a, c and d. The security appliance 20 fragments and distributes the key among n devices found on the secure network storage system 24 using the above-described sharing scheme. The storage key 26 is then associated with a particular host server 12a by the security appliance 20 updating its storage device associations. The security appliance 20 also stores where the key fragments have gone.

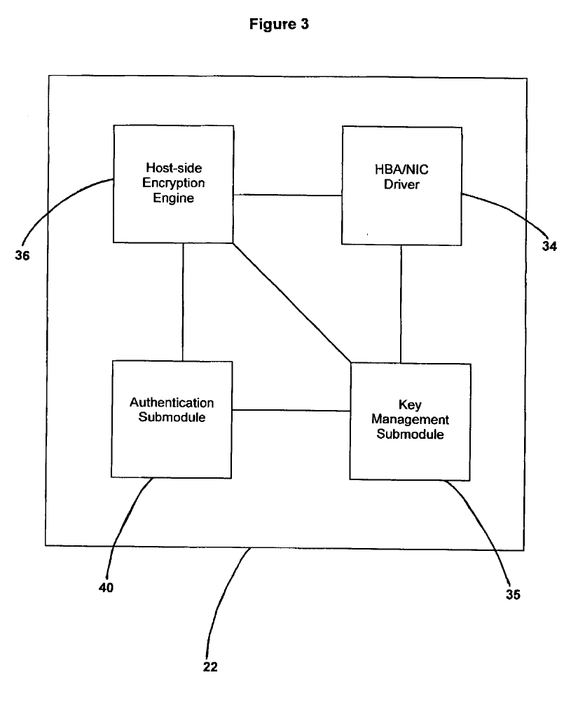

Referring to FIG. 3, there is illustrated a host storage encryption driver (HSED) 22 in accordance with a preferred embodiment of an invention. Preferably, the HSED 22 is a device card or blade that can be installed on the host server 12a. Alternatively, the HSED 22 is a software module, which may be installed on the host server 12a. The HSED 22 includes/works transparently with a HBA/NIC driver 24 for communication with the storage system 11, a host-side encryption engine 36 for encrypting data to be stored and for decrypting data received from the storage network though the HBA/NIC driver 24, a key management submodule 35 for obtaining a key and associated storage identify information from the security appliance 20, and for providing the key to the host-side encryption engine 36 for encryption and decryption of data, and an authentication submodule 40 for authenticating the host computer server on which the HSED 22 is installed with the security appliance 20.

As shown in FIG. 4, the HSED 22 is installed on a host server 12a. In trying to write data through the HBA/NIC driver 24, the host operating system 28 provides data to the HSED 22. As shown, the HSED 22 encrypts data from the host operating system 28 before it is written to the HBA/NIC driver 24, and decrypts data read through the HBA/NIC driver 24 before forwarding it to the host operating system 28. As shown, all data flow between the HBA/NIC driver 24 and the SAN 11is encrypted.

Referring to FIG. 5, there is illustrated in a block diagram a security appliance 20 in accordance with a preferred embodiment of the invention. The security appliance 20 includes a network transport module 44 for communication with other elements of the secure network storage system 10, an authentication module 46 for authenticating the host storage encryption driver 22, a key management means 48 for providing a storage key and associated storage identity information to the HSED 22 following authentication, and a key storage means 58 for securely storing: a root key component 57 for signing all certificates in a secure storage network (FIG. 1) and all transactions that the security appliance 20 initiates and responds to, a master key component 50 for encrypting and decrypting the storage key before and after storage respectively, a key erasing module 54 for securely zeroizing/erasing storage on detection of tampering or improper access. The security appliance 20 contains an encryption engine 52 for performing all encryption and decryption. The key management module 48 is also operable to verify, via the network transport module 44, that the HSED 22 has erased the storage key at its end.

The interaction of the elements of FIGS. 1 through 5 will now be described in the context of a secure storage and retrieval operation. Before submitting any other requests to the security appliance 20, the HSED 22 must request an executed certificate from the security appliance 20. Accordingly, the key management submodule 35 of the HSED 22 submits such a request, which contains its public key and a shared secret known only to the HSED 22 and the security appliance 20. This request is then passed to the host-side encryption engine 36 for encryption using a randomly generated session key (which is encrypted under the security appliance 20 public key) and signing using the HSED 22 private key. The encrypted message is then transmitted to the security appliance 20 via the HBA/NIC driver 24, where it is received by the network transport module 44. From the network transport module 44, the encrypted request is forwarded to the encryption engine 52, which decrypts the session key using the appliance root key component 56. The encryption engine 52 then decrypts the request using the session key. The request is then passed to the authentication module 46, which authenticates the HSED 22 by verifying the shared secret. The key management module 48 generates and signs a certificate based on the HSED 22 public key using the root key component 56 and the encryption engine 52. Finally a response is created which contains the newly generated certificate and is encrypted using the session key and signed using the root key component 56 by the encryption engine 52. The encrypted response is then transported to the HSED 22 HBA/NIC driver by the security appliance 20 network transport module 44. The HSED 22 authentication submodule 40 then authenticates the security appliance 20 by verifying the response signature by using the host-side encryption engine 36 and the security appliance 20 public key. The response is then decrypted using the session key and the host-side encryption engine 36, which yields the certificate (the certificate is verified using the appliance 22 public key and the host-side encryption engine 36), which is given to the key management module 35 for all future messaging with the security appliance 20. Once the certificate has been received from the security appliance 20, this step need not be executed again. Instead, the HSED 22 can proceed immediately to request access to secure storage devices 18a either to store encrypted data, or to retrieve encrypted data.

To store encrypted data and read encrypted data, the HSED 22 generates an access request and a randomly generated session key (which will be stored in the request along with the HSED 22 certificate) using the host-side encryption module 36. The session key is encrypted using the appliance 20 public key and host-side encryption module 36. The host-side encryption module 36 then encrypts the access request (with the exception of the HSED 22 certificate) using the session key and signs the access request using the HSED 22 private key. The access request is then delivered to the security appliance 20 network transport module 44 via the HBA/NIC driver 24. When received by the network transport module 44 of the security appliance 20, the request is forwarded to the authentication module 46 which uses the encryption engine 52 to authenticate the HSED by verifying the request signature using the HSED 22 public key, which is extracted from the certificate found in the request. (first the certificate was verified by the appliance 20 to make sure it was signed by the root key component 56 ) Once authenticated the encryption engine 52 is used to decrypt the session key using the appliance 20 root key component 56. The session key is then used by the encryption engine 52 to decrypt the access request. Once the identify of the host server 12a is known (determined by the certificate found in the access request), the key management module 48 retrieves a list of storage key packages and associated storage device identity information for that HSED 22 from a host index 56. The appliance 20 then sends a response which contains the storage key and the identity of the associated storage device 18a for which the storage key works. The response is secured by encrypting the storage key and associated identity information using the HSED 22 transmitted session key and signing the response with the root key component 56, all of which is accomplished by the encryption engine 52. The response is then transmitted to the HSED 22 via the network transport module 44. The HSED 22 then authenticates the appliance 20 by verifying the response signature by using the appliance 22 public key with the host-side encryption engine 36. The appliance 22 then decrypts the response using the random session (it originally generated for the request) key to obtain the storage key and the identity of the secure storage device 18a for which the storage key works.

Then, as illustrated in FIG. 4, information from the host operating system is encrypted/decrypted using the storage key by the HSED 22 before being transmitted by the HBA/NIC driver 24 to the associated secure storage device 1Ba for that storage key. Optionally, after a pre-defined period or on the occurrence of some trigger event, the key erasing submodule 54 of the key management module 48 will send a message (using the above-described secure messaging method) to the HSED requesting the overwriting (zeroizing) of the storage key on the HSED 22. The HSED 22 will verify this message using the above-described methods and securely zeroize/erase the key. On successful completion the HSED 22 will notify the appliance 20 using the above-described secure messaging method.

Recall that the storage key is not saved on the security appliance 20, but is instead fragmented and saved on secure storage devices 18a in the storage area network 10. Thus, to retrieve the storage keys, the key management module 48 must retrieve the encrypted shares from the secure storage devices 18a in which they are stored, and, after decrypting these encrypted shares in the encryption engine 52 using the master key supplied by the master key component 50, determine the storage key from the shares in accordance with the secret sharing scheme described above. By distributing the storage of the storage key in this way, the secure secure network storage system 10 is made more disaster resistant. That is, if the storage key were stored in one place, and were erased, then the data encrypted using the storage key would be lost. However, as only t+1 shares and not all n shares must be retrieved in order to recover the storage key some of the information regarding the storage key can be lost while still enabling the storage key to be recovered.

A number of advantages flow from implementing the encryption host side. First, the transmission of the data from the host is rendered secure. If, on the other hand, the data is only encrypted within the storage area network, then the transmission to the storage area network is in the clear and hence is insecure. Alternatively, if the data is encrypted from the host to the storage area network and then is decrypted before being encrypted again for storage, processing capacity is needlessly used up. Further, by encrypting at the host server 12a, the processing capacity of the secure network storage system 10 is not used for encryption, thereby reducing the processing load placed on the secure network storage system 10 and the likelihood of bottlenecks forming. This is very important, as transparency is very important. In other words, it is important that users of the secure network storage system 10 not be unduly inconvenienced. Preferably, such users should be completely unaware of the encryption and decryption going on. This is only possible if the processing capacity of the secure network storage system 10 is not overburdened, which the present invention assists by having encryption performed host side. By this means, encryption and decryption can be implemented with little or no adverse impact on the operating systems and therefore on the users.

Other variations and modifications of the invention are possible. In particular, the principal architectural advantages of the invention are readily applicable in the domain of network attached storage as well. For example, in the foregoing description, the secure messaging protocol used between the HSED and security appliance was PKCS7. However, other security protocols, such as, for example, IPSec or SSL/TLS, may also be used. All such modifications or variations are believed to be in the sphere and the scope of the invention as defined by the claims appended hereto.

1. A host-side encryption module for installation on a host computer server connected to a secure network storage system by a data transfer architecture for transfer of data therebetween, the secure network storage system having a plurality of storage devices for storage of the data, the host-side encryption module comprising:
(a) an encryption/decryption means for encrypting data to be stored on the secure network storage system and for decrypting data received from the secure network storage system;
(b) an authentication means for authenticating the host computer server with a security system associated with the secure network storage system; and
(c) a key management means for
(i) obtaining a key and associated storage identity information from the security system after authentication, wherein the associated storage identity information designates an associated storage means for storing information encrypted using the storage key, and the associated storage means is in the plurality of storage means, and
(ii) providing the key to the encryption engine for encryption and decryption of data.

2. The host-side encryption module of claim 1wherein the host-side encryption module is provided by a device card installed on the host computer.

3. The host-side encryption module of claim 1wherein the host-side encryption module communicates with the security systems in accordance with a secure messaging protocol supported by the encryption engine.

4. The host-side encryption module of claim 1further comprising a key erasing means for erasing the key from the host computer server following encryption and decryption.

5. The host-side encryption module of claim 2 further comprising a network data transport means for receiving data from the secure network storage system and for transmitting data to the secure network storage system (not shown in drawings).

6. The host-side encryption module of claim 1wherein the host-side encryption module is provided by a software module installed on the host computer.

7. A security system for providing restricted access to data stored on a secure network storage system having a plurality of storage means, the security system comprising:
(a) data transfer means for communication with a host server computer and the secure network storage system;
(b) a host computer authentication means for authenticating a host computer;
(c) a key management means for issuing a storage key and associated storage identity information to the host computer following authentication, wherein the associated storage identity information designates an associated storage means for storing information encrypted using the storage key, and the associated storage means is in the plurality of storage means;
(d) a key storage means for securely storing the storage key and the associated storage identity information.

8. The security system as defined in claim 7 wherein the key storage means is operable to store the storage key in the secure network storage system.

9. The security system as defined in claim 8 further comprising
a master key hardware component for securely storing a master key for encrypting the storage key before storage and for decrypting the storage key after retrieval from storage.

10. The security system as defined in claim 7 wherein
the storage key
has an associated n shares, where n is a positive integer,
is indeterminable given any t shares in the n shares, where t is a positive integer less than n, and
is determinable given any t+1 shares in the n shares;
the key storage means is operable to store the storage key by storing each share of the n shares at an associated n locations in the plurality of storage devices and by associating the associated n locations with the host computer; and,
the key management module is operable to retrieve the t+1 shares from the plurality of storage devices and comprises an associated key assembly means for assembling the storage key using the t+1 shares.

11. The security system as defined in claim 8 wherein the key management module comprises an associated key erasing means for erasing the assembled symmetric key following storage of the symmetric key by the associated key storage means.

12. The security system as defined in claim 10 further comprising
a master key hardware component for securely storing a master key; and,
encryption/decryption means associated with the master key hardware component for encrypting each share of the n shares before storage and for decrypting each share of the n shares after retrieval from storage using the master key.

13. The security system as defined in claim 7 further comprising host index means for recording, for each storage means in the secure network storage system, the host servers having access to the storage means, wherein the key management means is operable to issue a storage key after authentication of a host computer if the host computer is recorded in the host index means as having access to the associated storage means for the storage key.

14. A secure storage network system comprising
(a) a host computer server;
(b) a storage system connected to the host computer server by a data transfer architecture for transfer of data therebetween, the storage system having a plurality of storage devices for storage of the data;
(c) a host-side encryption module installed on the host computer, and
(d) a security system for providing restricted access to data stored on the storage system,
wherein
(e) the host-side encryption module has
i) an encryption/decryption means for encrypting data to be stored on the secure network storage system and for decrypting data received from the secure network storage system;
(ii) an authentication means for authenticating the host computer server with a security system associated with the secure network storage system; and
(iii) a key management means for
obtaining a key from the security system after authentication, and
providing the key to the encryption engine for encryption and decryption of data;
(f) the security system includes
(i) data transfer means for communication with the host server computer and the secure network storage system;
(ii) a host computer authentication means for authenticating the host server computer;
(iii) a key management means for issuing a storage key to the host computer following authentication;
(iv) a key storage means for securely storing the storage key.

15. A computer program product for use on a host computer server, the computer program product comprising:
a recording medium;
means recorded on the medium for configuring the host computer server to provide
(a) an encryption/decryption means for encrypting data to be stored on the secure network storage system and for decrypting data received from the secure network storage system;
(b) an authentication module for authenticating the host computer server with a secure source associated with the secure network storage system; and
(c) a key management means for
(i) obtaining a key from the secure source after authentication, and
(ii) providing the key to the encryption engine for encryption and decryption of data.

16. The computer program product of claim 15 further comprising means recorded on the medium for configuring the host computer server to support communication with the security systems using a secure messaging protocol.

17. The computer program product of claim 15 further comprising means recorded on the medium for providing a key erasing means for erasing the key from the host computer server following encryption and decryption.

18. A host-side encryption module for installation on a host computer server connected to a secure network storage system by a data transfer architecture for transfer of data therebetween, the secure network storage system having a plurality of storage devices for storage of the data, the host-side encryption module comprising:
(a) an encryption/decryption means for encrypting data to be stored on the secure network storage system and for decrypting data received from the secure network storage system;
(b) an authentication means for authenticating the host computer server with a security system associated with the secure network storage system; and
(c) a key management means for
(i) obtaining a key from the security system after authentication, and
(ii) providing the key to the encryption engine for encryption and decryption of data.

19. A method of transferring data between a host computer server and a secure network storage system via a data transfer architecture, the secure network storage system having a plurality of storage devices for storage of the data, the method comprising:
(a) authenticating the host computer server with a security system associated with the secure network storage system;
(b) obtaining a storage key from the security system after authentication,
(c) performing an encryption/decryption operation comprising at least one of (i) encrypting and storing data on the secure network storage system, and (ii) retrieving and decrypting data stored on the secure network storage system.
